(19) United States
(12) Patent Application Publication
(10) Pub. No.: US 2012/0158937 A1
(43) Pub. Date: Jun. 21, 2012

(54) SYSTEM AND METHOD FOR MANIPULATING MULTIMEDIA STREAMS OF IP TELECOMMUNICATIONS FOR MULTIPLE IP-ENABLED USER DEVICES

(76) Inventor: Song Jae Lee, San Jose, CA (US)

(21) Appl. No.: 13/329,216

(22) Filed: Dec. 16, 2011

Related U.S. Application Data
(60) Provisional application No. 61/459,663, filed on Dec. 16, 2010.

(51) Int. Cl. G06F 15/173

(52) U.S. Cl. 709/223

(57) ABSTRACT

A technique for manipulating multimedia streams of IP telecommunications for multiple IP-enabled user devices is disclosed. The disclosed technique allows at least a portion of an IP telecommunication is manipulated to selected IP-enabled user devices. Various methods using the multimedia stream manipulation technique are presented.

### CROSS REFERENCE TO RELATED APPLICATION

This application is entitled to the benefit of U.S. Provisional Patent Application Ser. No. 61/459,663, filed on Dec. 16, 2010, which is incorporated herein by reference.

### FIELD OF THE INVENTION

The invention relates generally to internet protocol (IP) telecommunications, and more particularly to a system and method for managing multimedia streams of IP telecommunications.

### BACKGROUND OF THE INVENTION

With the advent of the Internet, many traditional telecommunications, such as telephone calls and television transmissions, as well as data communications, are being transmitted through the Internet using IP. Thus, IP telecommunications are now widely used to transmit multimedia streams to and from IP-enabled user devices. Multimedia streams transmitted through the Internet may include audio data, video data, picture or image data, graphics data, textual data or any combination thereof.

In the past, IP-enabled user devices were mostly personal computers, such as desktop computers, laptop computers, tablet computers and. However, recently, other types of IP-enabled user devices have been developed, such as IP-enabled wireless mobile devices, e.g., personal digital assistants and smartphones, IP-enabled television, IP-enabled radio and other IP-enabled consumer electronics. With the different types of IP-enabled user devices, a user may have multiple IP-enabled devices to receive and/or send multimedia streams. Thus, there is a need for a system and method for managing multimedia streams of IP telecommunications for different IP-enabled user devices.

### SUMMARY OF THE INVENTION

A technique for manipulating multimedia streams of IP telecommunications for multiple IP-enabled user devices is disclosed. The disclosed technique allows at least a portion of an IP telecommunication is manipulated to selected IP-enabled user devices. Various methods using the multimedia stream manipulation technique are presented.

In an embodiment, a method for manipulating multimedia streams of IP telecommunications for multiple IP-enabled user devices comprises establishing a first IP connection between a first IP-enabled user device and a second IP-enabled user device for an IP telecommunication including at least one multimedia stream, facilitating a first transmission of at least a first portion of the at least one multimedia stream of the IP telecommunication between the first IP-enabled device and the second IP-enabled user device through the first IP connection, receiving, at the first IP-enabled user device, a request to direct at least a second portion of the at least one multimedia stream of the IP telecommunication to a third IP-enabled user device, establishing a second IP connection between the first IP-enabled user device and the third IP-enabled user device so that the at least the second portion of the at least one multimedia stream of the IP telecommunication is transferred between the first IP-enabled user device and the third IP-enabled user device, and facilitating a second transmission of the at least the second portion of the at least one multimedia stream of the IP telecommunication between the first IP-enabled device and the third IP-enabled user device through the second IP connection. In an embodiment, computer executable instructions, which when executed by a computer, implement this method for manipulating multimedia streams of IP telecommunications for multiple IP-enabled user devices are stored in a non-transitory storage medium.

In an embodiment, a method for manipulating multimedia streams of IP telecommunications for multiple IP-enabled user devices comprises establishing a first IP connection between a first IP-enabled user device and a second IP-enabled user device for an IP telecommunication including at least one multimedia stream, facilitating a first transmission of at least a first portion of the at least one multimedia stream of the IP telecommunication between the first IP-enabled device and the second IP-enabled user device through the first IP connection, and cooperating with a third IP-enabled user device to establish a second IP connection between the third IP-enabled user device and the second IP-enabled user device so that at least a second portion of the at least one multimedia stream of the IP telecommunication is transferred between the third IP-enabled user device and the second IP-enabled user device, wherein the IP telecommunication is conducted using both the first IP connection between the first IP-enabled user device and the second IP-enabled user device and the second IP connection between the third IP-enabled user device and the second IP-enabled user to transfer the at least the first portion and the at least the second portion of the at least one multimedia stream of the IP telecommunication between the first, second and third IP-enabled user devices. In an embodiment, computer executable instructions, which when executed by a computer, implement this method for manipulating multimedia streams of IP telecommunications for multiple IP-enabled user devices are stored in a non-transitory storage medium.

In an embodiment, an IP-enabled user device comprises a user interface module configured to receive user input, an IP communication core configured establish at least one IP connection to transmit and receive IP data, including different multimedia streams of IP telecommunications, an inter-device handling module configured to perform functions to interface with other IP-enabled devices to determine which of the IP-enabled user devices will handle the different multimedia streams of the IP telecommunication, and a device command module coupled to the user interface module, the IP communication core and the inter-device handling module. The device command module is configured to establish a first IP connection between the IP-enabled user device and a second IP-enabled user device for an IP telecommunication including at least one multimedia stream. The device command module is further configured to facilitate a first transmission of at least a first portion of the at least one multimedia stream of the IP telecommunication between the IP-enabled device and the second IP-enabled user device through the first IP connection. The device command module is further configured to establish a second IP connection between the IP-enabled user device and the third IP-enabled user device so that the at least the second portion of the at least one multimedia stream of the IP telecommunication is transferred between the IP-enabled user device and the third IP-enabled user device. The device command module is further configured to facilitate a second transmission of the at least the second portion of the at least one multimedia stream of the IP telecommunication between the first IP-enabled device and the third IP-enabled user device through the second IP connection.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a schematic block diagram of an IP network environment in accordance with an embodiment of the invention.

FIG. 2 is a block diagram of a gatekeeper server in the IP network environment in accordance with an embodiment of the invention.

FIG. 3 is a block diagram of a representative IP-enabled user device of IP-enabled user devices in the network environment in accordance with an embodiment of the invention.

FIG. 4 illustrates the IP network environment without the network shown in FIG. 1, illustrating a process for redirecting bidirectional multimedia streams of IP telecommunications in accordance with an embodiment of the invention.

FIGS. 5A and 5B is a flow diagram of the process for redirecting bidirectional multimedia streams of IP telecommunications in accordance with an embodiment of the invention.

FIG. 6 illustrates the IP network environment without the network shown in FIG. 1, illustrating a process for redirecting unidirectional multimedia streams of IP telecommunications in accordance with an embodiment of the invention.

FIGS. 7A and 7B is a flow diagram of the process for redirecting unidirectional multimedia streams of IP telecommunications in accordance with an embodiment of the invention.

FIGS. 8A and 8B illustrate a technique of redirecting one or more multimedia streams of an IP telecommunication from a first IP-enabled user device to a second IP-enabled user device without having to terminate the IP telecommunication in accordance with an embodiment of the invention.

FIG. 9 illustrates a technique of using distributed multiple multimedia streams of an IP telecommunication from multiple IP-enabled user devices to a single IP-enabled device in accordance with an embodiment of the invention.

FIGS. 10A and 10B illustrate a technique of relaying one or more multimedia streams of an IP telecommunication from one of the IP-enabled user devices to other IP-enabled user device in accordance with an embodiment of the invention.

FIG. 11 is a flow diagram of a method for polishing semiconductor wafers in accordance with an embodiment of the invention.

FIG. 12 is a flow diagram of a method for polishing semiconductor wafers in accordance with another embodiment of the invention.

### DETAILED DESCRIPTION

It will be readily understood that the components of the embodiments as generally described herein and illustrated in the appended figures could be arranged and designed in a wide variety of different configurations. Thus, the following detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

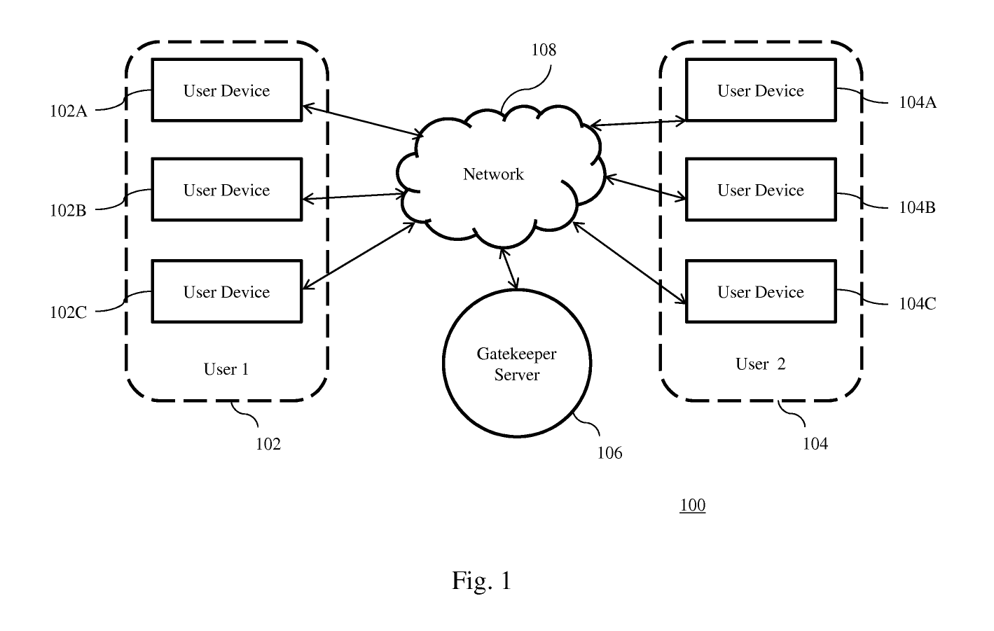

FIG. 1 is a schematic block diagram of an IP network environment 100 in accordance with an embodiment of the invention. The IP network environment includes a number of IP-enabled user devices 102A, 102B, 102C, 104A, 104B and 104C and a gatekeeper server 106, which can communicate with each other through a network 108. In the illustrated embodiment, the IP-enabled user devices 102A, 102B and 102C are owned or under the control of a first user 102. In addition, these IP-enabled user devices 102A, 102B and 102C are linked with each other as being associated with the first user. Similarly, the IP-enabled user devices 104A, 104B and 104C are owned or under the control of a second user 104. In addition, these IP-enabled user devices 104A, 104B and 104C are linked with each other as being associated with the second user.

The network 108 may include one or more private and public networks, and may further include one or more wireless service providers. In particular, the network may include the Internet. The network is configured to connect the IP-enabled user devices 102A, 102B, 102C, 104A, 104B and 104C for IP telecommunications. In the illustrated embodiment, the IP network environment 100 is shown as including six IP-enabled user devices and a single gatekeeper server. However, in other embodiments, the IP network environment may include any number of IP-enabled devices and gatekeeper servers. As described in more detail below, the IP network environment allows users of the IP-enabled user devices to manage multimedia streams of IP telecommunications so that some or all of the multimedia streams can be manipulated, e.g., redirected, relayed, separated and/or combined, to other IP-enabled user devices. As used herein, multimedia streams may include audio data (live or recorded), video data (live or recorded), picture or image data, graphics data, textual data or any combination thereof. These different types of data can be in any format. For example, the audio data may be in MIDI format.

The gatekeeper server 106 operates to maintain current IP addresses for the IP-enabled user devices 102A, 102B, 102C, 104A, 104B and 104C and provide the maintained IP addresses to the IP-enabled user devices when needed. Gatekeeper servers are well known in the field of IP networks, and thus, the gatekeeper server is not described herein in detail. The gatekeeper server allows users to register their IP-enabled user devices so that the gatekeeper server can maintain current IP addresses of these IP-enabled user devices. In addition, when one of the registered IP-enabled user devices, i.e., the calling IP-enabled user device, wants to initiate an IP telecommunication with another registered IP-enabled user device, i.e., the called IP-enabled user device, the gatekeeper will provide the current IP address of the called IP-enabled user device to the calling IP-enabled user device so that the IP telecommunication can be established between the calling IP-enabled user device and the called IP-enabled user device.

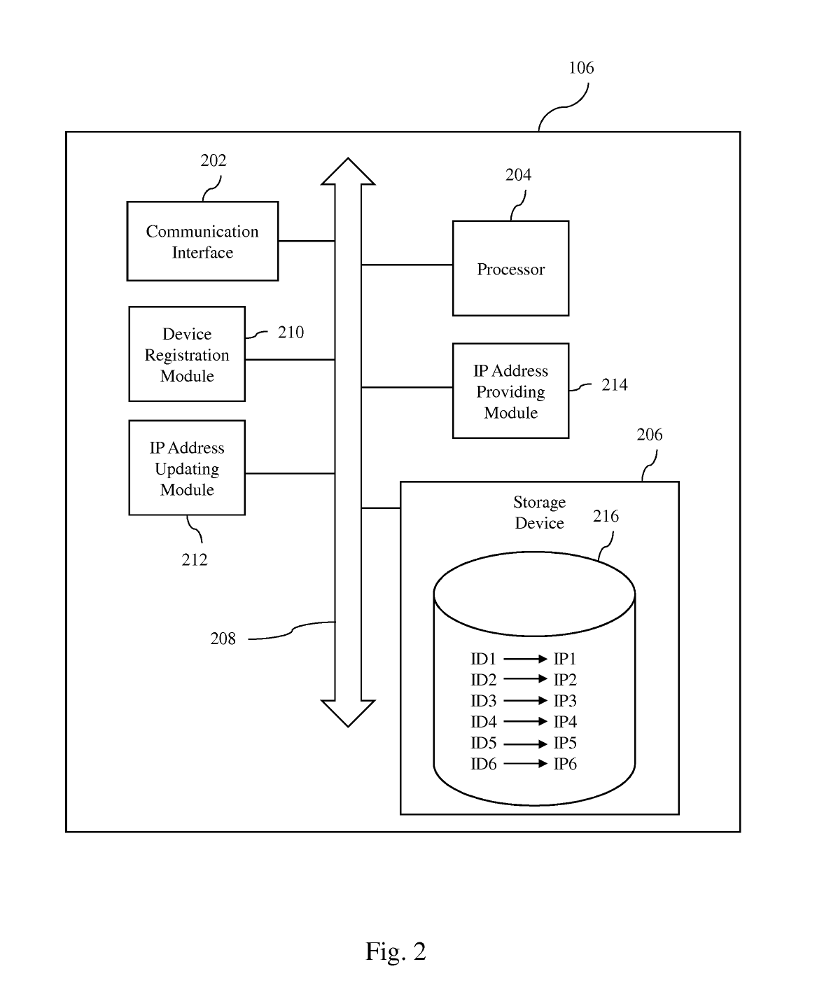

Turning now to FIG. 2, components of the gatekeeper server 106 in accordance with an embodiment is shown. As shown in FIG. 2, the gatekeeper server includes a communication interface 202, at least one processor 204 and at least one storage device 206 that are connected to a data bus 208. The communication interface enables communications with other devices, such as the IP-enabled user devices, via electronic messages, for example, IP messages. The processor may include a multifunction processor and/or an application-specific processor. The processor can be any processor commonly found in a server. The storage device can be any type of computer memory, such as read only memory (ROM), flash memory, random access memory (RAM) or a hard disk drive.

As shown in FIG. 2, the gatekeeper server 106 further includes a device registration module 210, an IP address updating module 212 and an IP address providing module 214. The device registration module interfaces with IP-enabled user devices so that the IP-enabled user devices can register with the gatekeeper server so that their current IP addresses are maintained by the gatekeeper server. In an embodiment, the device registration module creates identification data for the registering IP-enabled user devices. The identification data of the registering IP-enabled user devices is stored in a database 216, which can be located in the storage device 206. In FIG. 2, the database is shown to include identifiers ID1, ID2, ID3, ID4, ID5 and ID6 that identifies the IP-enabled user devices 102A, 102B, 102C, 104A, 104B and 104C, respectively. In addition, the current IP address for each of the registering IP-enabled user devices is mapped to the corresponding identifier. In FIG. 2, the database is shown to include IP addresses IP1, IP2, IP3, IP4, IP5 and IP6 that are mapped to the identifiers ID1, ID2, ID3, ID4, ID5 and ID6, respectively. Thus, the IP addresses IP1, IP2, IP3, IP4, IP5 and IP6 are the current IP addresses of the IP-enabled user devices 102A, 102B, 102C, 104A, 104B and 104C, respectively.

The IP address updating module 212 of the gatekeeper server 106 interfaces with the registered IP-enabled user devices to update the current IP addresses of the registered IP-enabled user devices. In some embodiments, the registered IP-enabled user devices will provide their new IP addresses as soon as their IP addresses are changed. In other embodiments, the IP address updating module may periodically poll the registered IP-enabled user devices for their current IP addresses.

The IP address providing module 214 of the gatekeeper server 106 provides the current IP addresses of IP-enabled user devices that are maintained by the gatekeeper server to the requesting registered IP-enabled user devices. Using the identifier for the requesting IP-enabled user device, the IP address providing module provides the current IP address of the requested IP-enabled user device using the information stored in the database.

In an embodiment, the device registration module 210, the IP address updating module 212 and the IP address providing module 216 are implemented as software stored in a computer readable medium, such as the storage device 206, which is executed by the processor to perform the functions of the modules. However, in other embodiments, the device registration module, the IP address updating module and the IP address providing module may be implemented in any combination of software, firmware and hardware.

Turning back to FIG. 1, the IP-enabled user devices 102A, 102B, 102C, 104A, 104B and 104C in the IP network environment 100 can be any type of a computing device that can communicate with other IP-enabled devices using IP. The IP-enabled user devices may be desktop computers, notebook computers, servers, netbooks, tablet computers, such as iPads, general media players, set-top boxes, cellular phones, smart phones, such as iPhone and Android phone, smart televisions (TVs), standalone webcam, a network storage, or any combination thereof. “Android” is a trademark of Google Inc., and “iPads” and “iPhone” is a trademark of Apple Inc.

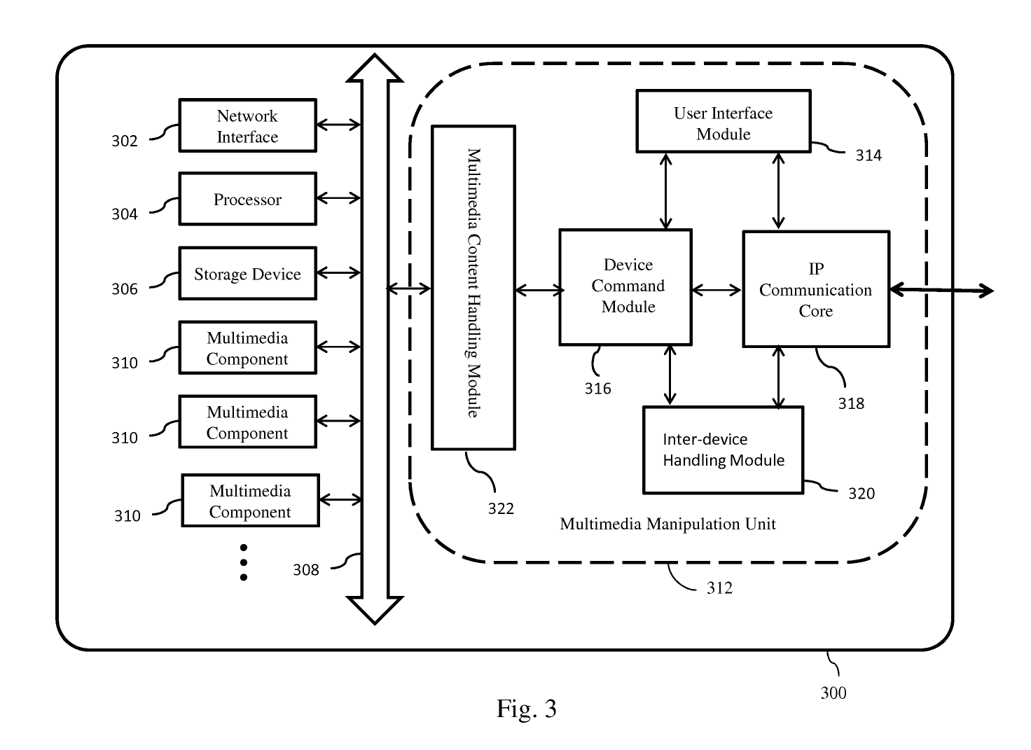

Turning now to FIG. 3, components of a representative IP-enabled user device 300 of the IP-enabled user devices 102A, 102B, 102C, 104A, 104B and 104C shown in FIG. 1 in accordance with an embodiment of the invention are shown. The IP-enabled user device 300 may include additional software/hardware components, depending on the particular type of the IP-enabled user device. As an example, if the IP-enabled user device is a smart phone, the IP-enabled user device would include a radio frequency (RF) transmitter/receiver to transmit and receive cellular telephone calls.

As shown in FIG. 3, the IP-enabled user device 300 includes various common components found in computer systems, such as a network interface 302, a processor 304, a storage device 306, and a bus 308. The network interface of the IP-enabled user device allows the IP-enabled user device to transmit and receive signals for IP telecommunications with other IP-enabled user devices, such as the IP-enabled user devices 102A, 102B, 102C, 104A, 104B and 104C. As an example, the network interface may be a WiFi card or an Ethernet card. The processor may include a multifunction processor and/or an application-specific processor. The processor can be any processor commonly found in computer systems, including wireless mobile devices. The storage device can be any type of computer memory, such as read only memory (ROM), flash memory, random access memory (RAM) or a hard disk drive. The storage device may be used to store multimedia files to be transmitted to other IP-enabled user devices.

The IP-enabled user device 300 further includes one or more multimedia components 310 that are configured to generate multimedia streams for transmission or to play multimedia streams received from an external source, such as another IP-enabled user device. As an example, the IP-enabled user device may include a camera, a microphone, a screen (e.g., a touchsceen), a speaker, an audio player (e.g. MP3 player), a video player, a screen capture unit (also known as a “frame grabber” that can convert analog video stream or still images into digital format, such as avi, mov or wmv formats), and any other known multimedia component that can used to generate or play multimedia contents. The exact types of multimedia components included in the IP-enabled user device are not critical to the invention disclosed herein. The multimedia components included in the IP-enabled user device may be implemented as software, hardware, firmware or any combination thereof.

The IP-enabled user device 300 further includes a multimedia manipulation unit 312, which is configured to allow a user of the device to manipulate one or more multimedia streams of IP telecommunications. The multimedia manipulation unit includes a user interface module 314, a device command module 316, an IP communication core 318, an inter-device handling module 320 and a multimedia content handling module 322. The user interface module, the device command module, the IP communication core, the inter-device handling module and the multimedia content handling module may be implemented in software, firmware, hardware or any combination thereof. In an embodiment, the multimedia manipulation unit is a software application, which may be specifically designed to run on wireless mobile devices and tablet computers. Typically, the software applications that are specifically designed to run on wireless mobile devices and tablet computers are commonly referred to as “apps,” which are typically downloaded from online app stores and installed on the devices to which the apps were downloaded.

The user interface module 314 interacts with a user of the IP-enabled user device 300 to receive user inputs and display results and multimedia outputs to the user. The user interface module may receive user inputs from any source, such as a touchscreen, audio commands, or physical input devices of the IP-enabled user, e.g., keys of a dialpad or capacitive sensors. The user interface module may also generate a graphic user interface for the user to enter user inputs and/or to view various outputs, which may be results of the user inputs and or received multimedia content.

The device command module 316 receives user inputs through the user interface module 314 and controls the IP-enabled user device 300 to generate and play multimedia contents via the multimedia content handling module 322. The device command module also sends and receives multimedia contents thru the IP communication core 318 and handles communications among other IP-enabled user devices thru the inter-device handling module 320 to cooperate with other IP-enabled user devices to facilitate multimedia stream manipulations. As described in more detail below, the device command module performs operations to actively or indirectly manipulate multimedia streams transmitted from the IP-enabled user device 300 or received at the IP-enabled user device 300. In some embodiments, the device command modules in the IP-enabled user devices involved in multimedia stream manipulations cooperate to control the execution of the multimedia streams manipulations.

The IP communication core 318 operates to take care of communications to outside of the IP-enabled user device 300. The IP communication core performs the functions necessary to initiate and establish an IP telecommunication between the IP-enabled user device 300 and any other IP-enabled user device. The IP communication core also performs the functions necessary to respond to a request to establish an IP telecommunication from another IP-enabled user device. The IP communication core also performs the functions necessary to communicate with the gatekeeper server 106.

The inter-device handling module 320 performs the functions necessary to transmit and receive communications to other IP-enabled user devices in response to instructions from the device command module 316. As described below, the inter-device handling module facilitates communications between IP-enabled user devices that have been associated or linked by the user of the IP-enabled user devices to manipulate one or more multimedia streams between the linked IP-enabled user devices. For example, associated or linked IP-enabled user devices may be devices that are owned or under control by the same user.

The multimedia content handling module 322 performs the functions necessary to interface with one or more of the multimedia components 310 of the IP-enabled user device 300 to generate and/or play multimedia content in response to instructions from the device command module 316 or in accordance with set parameters. As an example, the multimedia content handling module may automatically facilitate play of audio data received as a multimedia stream by transmitting the audio data to an audio player of the IP-enabled user device 300. As another example, if an IP telecommunication is established for a video conferencing, the multimedia content handling module may retrieve or receive video data from a camera of the IP-enabled user device 300 and audio data from a microphone of the IP-enabled user device 300, and transmit the video and audio data to the IP communication core 318 for transmission.

In some embodiments, the IP-enabled user devices in accordance with an embodiment of the invention of the invention are able to facilitate redirection of one or more multimedia streams of an IP telecommunication established between two of the IP-enabled user devices to a linked third IP-enabled user device. Thus, users of the IP-enabled user devices can switch between linked IP-enabled user devices without having to terminate the IP telecommunication. This technique can be used in IP telecommunications that involve bidirectional multimedia streaming or unidirectional multimedia streaming.

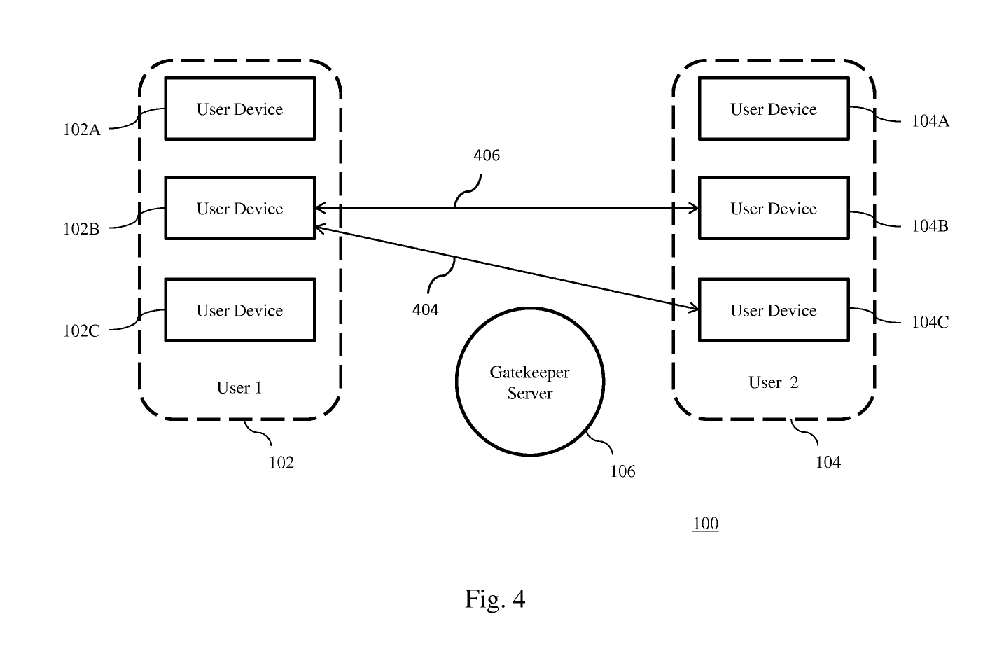

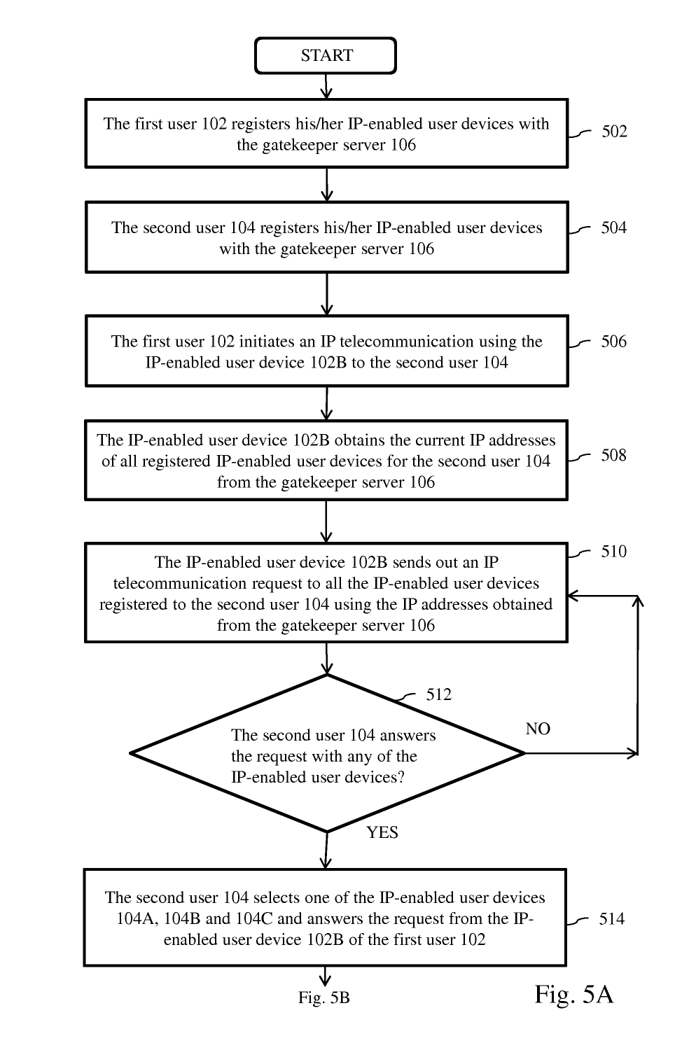

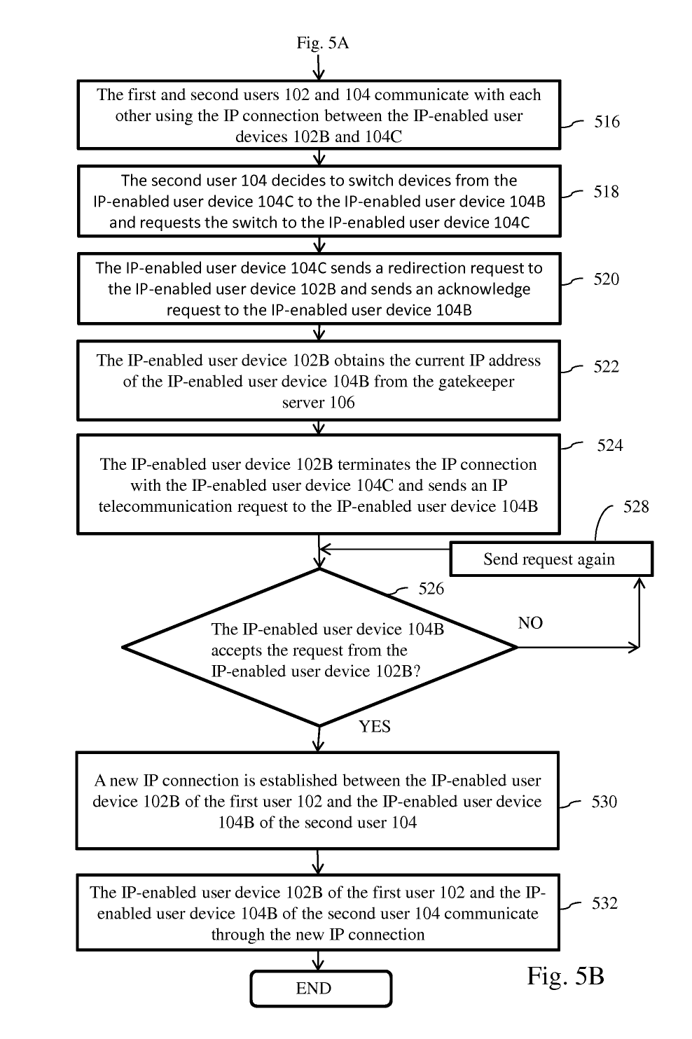

The technique of redirecting bidirectional multimedia streams of IP telecommunications in accordance with an embodiment of the invention is described with reference to FIGS. 4, 5A and 5B. FIG. 4 illustrates the IP network environment 100 shown in FIG. 1 without the network 108. FIGS. 5A and 5B is a flow diagram of a process for redirecting bidirectional multimedia streams of IP telecommunications in accordance with an embodiment of the invention.

As illustrated in FIGS. 5A and 5B, the process for redirecting bidirectional multimedia streams of IP telecommunications begins at block 502, where the first user 102 registers his/her IP-enabled user devices 102A, 102B and 102C with the gatekeeper server 106 using one or more of the IP-enabled user devices 102A, 102B and 102C or another user device that can communicate with the gatekeeper server. At block 504, the second user 104 also registers his/her IP-enabled user devices 104A, 104B and 104C with the gatekeeper server using one or more of the IP-enabled user devices or another user device that can communicate with the gatekeeper server.

At block 506, the first user 102 initiates an IP telecommunication, which may involve one or more multimedia streams, using the IP-enabled user device 102B to the second user 104 to establish the IP telecommunication with at least one of the IP-enabled user devices 104A, 104B and 104C of the second user. At block 508, the IP-enabled user device 102B obtains the current IP addresses of all registered IP-enabled user devices for the second user from the gatekeeper server 106. As an example, the IP addresses are obtained by sending a request message, e.g., an IP request message, to the gatekeeper server and receiving the IP addresses from the gatekeeper server in a response, e.g., an IP response message. At block 510, the IP-enabled user device 102B sends out an IP telecommunication request to all the IP-enabled user devices registered to the second user using the IP addresses obtained from the gatekeeper server.

At block 512, if the second user 104 answers the request with any of the IP-enabled user devices 104A, 104B and 104C, the process proceeds to block 514. However, if the second user does not answer the request with any of the IP-enabled user devices, then the process proceeds back to block 514, where another request is sent by the IP-enabled user device 102B. The IP-enabled user device 102B may be configured to terminate this loop and end the process after a predetermined number of sent requests.

At block 514, the second user 104 selects one of the IP-enabled user devices 104A, 104B and 104C and answers the request from the IP-enabled user device 102B of the first user 102 so that an IP connection is established between the IP-enabled user device 102B of the first user and the selected the IP-enabled user device of the second user, e.g., the IP-enabled user device 104C. The IP connection is illustrated in FIG. 4 using arrow 404. At block 516, the first and second users communicate with each other using the IP connection between the IP-enabled user devices 102B and 104C by transmitting and receiving one or more multimedia streams through the IP connection.

At block 518, the second user 104 decides to switch devices from the IP-enabled user device 104C to the IP-enabled user device 104B and requests the switch to the IP-enabled user device 104C via user input. At block 520, the IP-enabled user device 104C sends a redirection request to the IP-enabled user device 102B and sends an acknowledge request to the IP-enabled user device 104B. At block 522, the IP-enabled user device 102B obtains the current IP address of the IP-enabled user device 104B from the gatekeeper server 106. At block 524, the IP-enabled user device 102B terminates the IP connection with the IP-enabled user device 104C and sends an IP telecommunication request to the IP-enabled user device 104B.

At block 526, if the IP-enabled user device 104B accepts the request from the IP-enabled user device 102B, then the process proceeds to block 530. However, if the IP-enabled user device 104B does not accept the request, then the process proceeds to block 528, where another request is sent. The acceptance of this request may be automatically performed by the multimedia manipulation unit of the IP-enabled user device 104B or may require input from the second user 104. The IP-enabled user device 102B may be configured to terminate this loop and end the process after a predetermined number of sent requests.

At block 530, a new IP connection is established between the IP-enabled user device 102B of the first user 102 and the IP-enabled user device 104B of the second user. The IP connection is illustrated in FIG. 4 using arrow 406. At block 532, the IP-enabled user device 102B of the first user and the IP-enabled user device 104B of the second user 104 communicate with each other by transmitting and receiving one or more multimedia streams through the new IP connection.

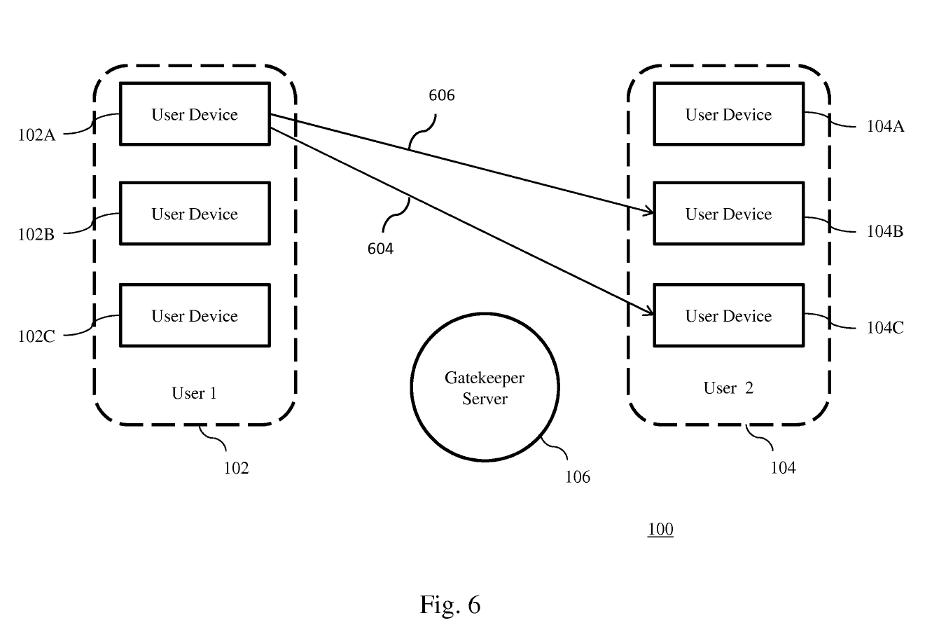

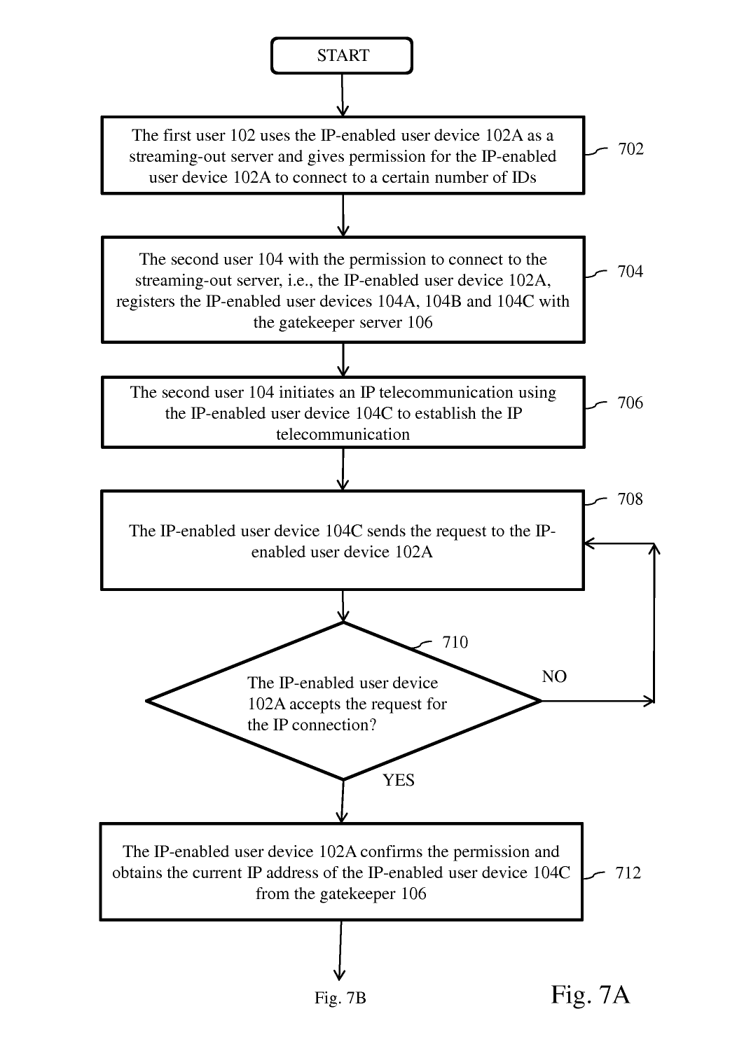

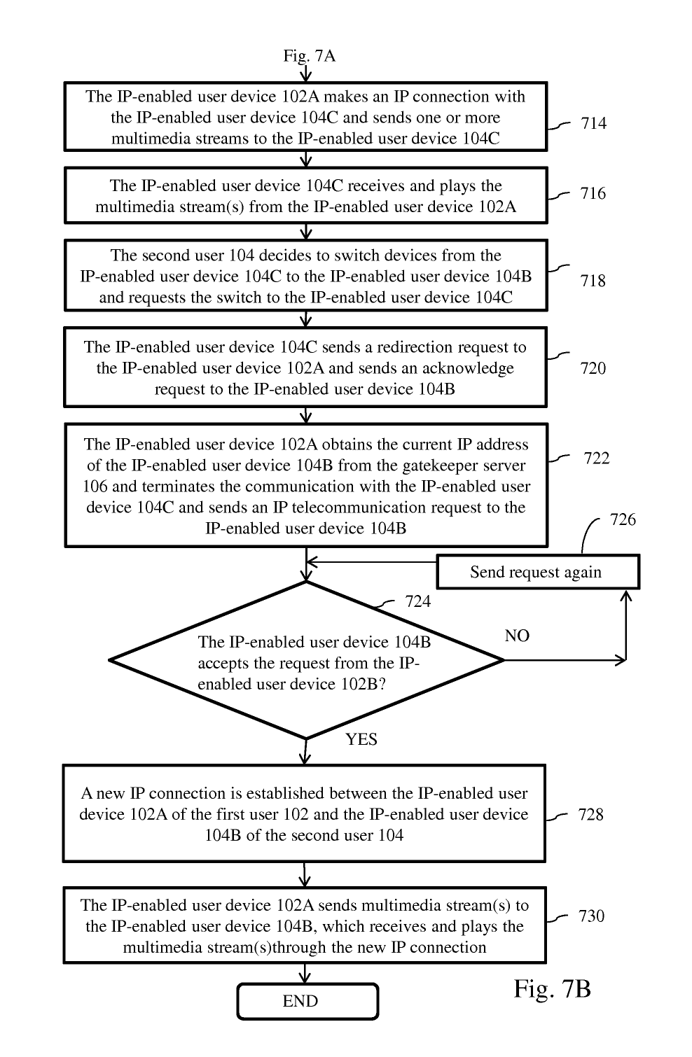

The technique of redirecting unidirectional multimedia streams of IP telecommunications in accordance with an embodiment of the invention is described with reference to FIGS. 6, 7A and 7B. FIG. 6 illustrates the IP network environment 100 shown in FIG. 1 without the network 108. In this embodiment, the first user 102 has only the IP-enabled user device 102A. FIGS. 7A and 7B is a flow diagram of a process for redirecting unidirectional multimedia streams of IP telecommunications.

As illustrated in FIGS. 7A and 7B, the process for redirecting unidirectional multimedia streams of IP telecommunications begins at block 702, where the first user 102 uses the IP-enabled user device 102A as a streaming-out server and gives permission for the IP-enabled user device 102A to connect to a certain number of identifications (IDs). At block 704, the second user 104 with the permission to connect to the streaming-out server, i.e., the IP-enabled user device 102A, registers the IP-enabled user devices 104A, 104B and 104C with the gatekeeper server 106 using one or more of the IP-enabled user devices or another user device that can communicate with the gatekeeper server with the ID of the second user 104.

At block 706, the second user 104 initiates an IP telecommunication, which may involve one or more multimedia streams, using the IP-enabled user device 104C to establish the IP telecommunication with the IP-enabled user device 102A. At block 708, the IP-enabled user device 104C sends the request to the IP-enabled user device 102A.

At block 710, if the IP-enabled user device 102A accepts the request for the IP connection, then the process proceeds to block 712. However, if the IP-enabled user device 102A does not accept the request for the IP connection, then the process proceeds back to block 708, where another request is sent by the IP-enabled user device 104C to the IP-enabled user device 102A. The IP-enabled user device 104C may be configured to terminate this loop and end the process after a predetermined number of sent requests.

At block 712, the IP-enabled user device 102A confirms the permission and obtains the current IP address of the IP-enabled user device 104C from the gatekeeper 106. As an example, the IP address is obtained by sending a request message, e.g., an IP request message, to the gatekeeper server and receiving the IP address from the gatekeeper server in a response, e.g., an IP response message. At block 714, the IP-enabled user device 102A makes an IP connection with the IP-enabled user device 104C and sends one or more multimedia streams to the IP-enabled user device 104C. The IP connection is illustrated in FIG. 6 using arrow 604. At block 716, the IP-enabled user device 104C receives and plays the multimedia stream(s) from the IP-enabled user device 102A.

At block 718, the second user 104 decides to switch devices from the IP-enabled user device 104C to the IP-enabled user device 104B and requests the switch to the IP-enabled user device 104C via user input. At block 720, the IP-enabled user device 104C sends a redirection request to the IP-enabled user device 102A and sends an acknowledge request to the IP-enabled user device 104B. At block 722, the IP-enabled user device 102A obtains the current IP address of the IP-enabled user device 104B from the gatekeeper server 106 and terminates the communication with the IP-enabled user device 104C and sends an IP telecommunication request to the IP-enabled user device 104B.

At block 724, if the IP-enabled user device 104B accepts the request from the IP-enabled user device 102B, then the process proceeds to block 728. However, if the IP-enabled user device 104B does not accept the request, then the process proceeds to block 726, where another request is sent. The acceptance of this request may be automatically performed by the multimedia manipulation unit of the IP-enabled user device 102A or may require input from the second user 104. The IP-enabled user device 102A may be configured to terminate this loop and end the process after a predetermined number of sent requests.

At block 728, a new IP connection is established between the IP-enabled user device 102A of the first user 102 and the IP-enabled user device 104B of the second user 104. The new IP connection is illustrated in FIG. 6 using arrow 606. At block 730, the IP-enabled user device 102A sends one or more multimedia streams to the IP-enabled user device 104B, which receives and plays the multimedia stream(s).

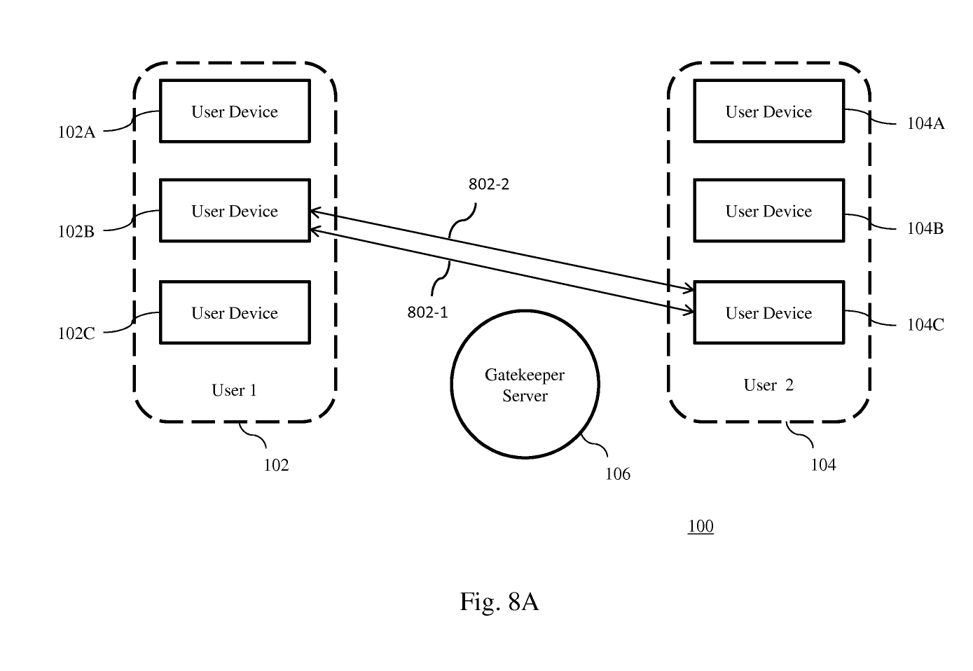

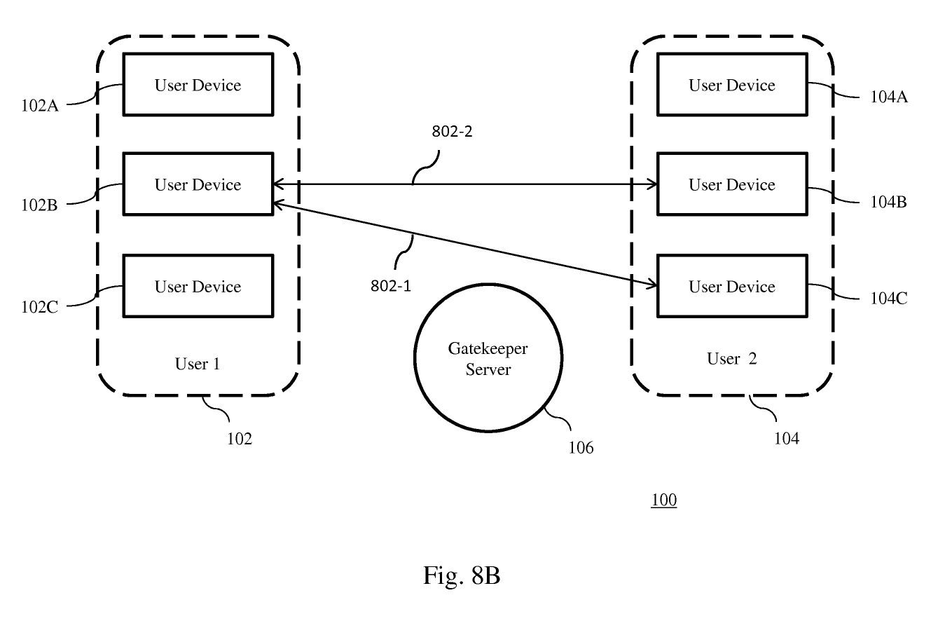

In some embodiments, the IP-enabled user devices in accordance with an embodiment of the invention are able to facilitate redirection of one or more multimedia streams of an IP telecommunication established between two of the IP-enabled user devices to a linked third IP-enabled user device so that the multimedia streams are transmitted to and from multiple IP-enabled user devices. Thus, users of the IP-enabled user devices can redirect one or more multimedia streams of an IP telecommunication to another linked IP-enabled user device without having to terminate the IP telecommunication. This technique is illustrated with reference to FIGS. 8A and 8B.

As illustrated in FIG. 8A, the first and second users 102 and 104 have established an IP telecommunication between the IP-enabled user device 102B and the IP-enabled user device 104C and are communicating with each other using the connected IP-enabled user devices. The IP telecommunication includes more than one multimedia stream. In this example, the IP telecommunication includes a first multimedia stream 802-1 and a second multimedia stream 802-2. During the IP telecommunication, the second user 104 wants to redirect a certain part of the IP telecommunication, i.e., e.g., the second multimedia stream of the IP telecommunication, to the IP-enabled user device 104B. For example, if the IP telecommunication is a video call, the second user may want to send only the video stream of the video call to another device, e.g., the IP-enabled user device 104B, which may be a smart TV, but still wants to keep using the audio capturing component, such as a microphone, and the audio playing component, such as a speaker, of the IP-enabled user device 104C. In order to execute this multimedia redirection, the second user enters the appropriate command into the IP-enabled user device 104C to redirect the second multimedia stream to the IP-enabled user device 104B. The multimedia manipulation unit in the IP-enabled user device 104C, in particular the device command module, sends the command to the IP-enabled user device 102B and notifies the multimedia manipulation unit in the IP-enabled user device 104B regarding the multimedia redirection to prepare to receive the redirected multimedia stream, i.e., the second multimedia stream. In response to the message from the IP-enabled user device 104C, the device command module in the IP-enabled user device 102B inquires the gatekeeper 106 to receive the current IP address of the IP-enabled user device 104B and then starts to send the redirected multimedia stream 802-1 to the IP-enabled user device 104B, while continuing to send the first multimedia stream 802-1 to the IP-enabled user device 104C, as illustrated in FIG. 8B. In this embodiment, the first and second multimedia streams may be bidirectional or unidirectional multimedia streams.

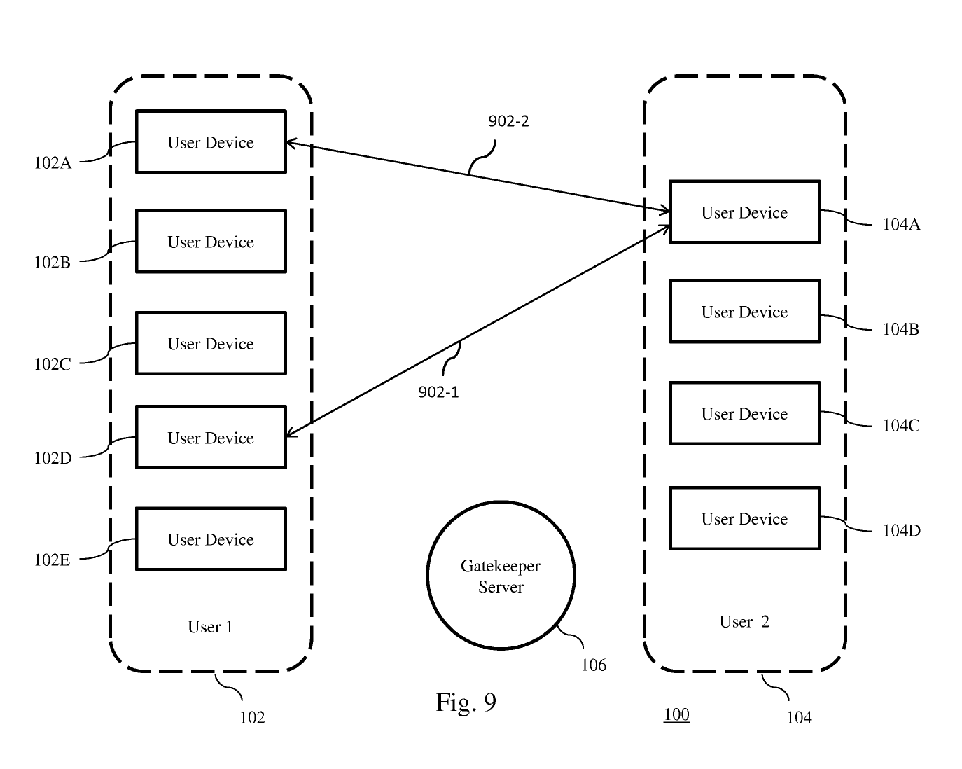

In some embodiments, the IP-enabled user devices in accordance with an embodiment of the invention are able to facilitate using distributed multiple multimedia streams of an IP telecommunication from multiple IP-enabled user devices to a single IP-enabled device. Thus, users of the IP-enabled user devices can use multiple IP-enabled devices to transmit and/or receive multimedia streams of the same IP telecommunication. This technique is illustrated with reference to FIG. 9. In FIG. 9, the first user 102 is shown as having two additional IP-enabled user devices 102D and 102E, and the second user 192 is shown as having one additional IP-enabled user device 104D.

In FIG. 9, the first and second users 102 and 104 want to establish an IP telecommunication involving multiple multimedia streams 902-1 and 902-2. The first user has selected the IP-enabled user device 102A for the IP telecommunication, but the IP-enabled user device 102A lacks certain multimedia generating/playing component(s). Thus, the first user decides to use the IP-enabled user device 102D, which has the lacking multimedia generating/playing component(s). For example, the first user wants to make a video call to the second user but his/her cell phone (e.g., the IP-enabled user device 102A) does not have a camera. Thus, the first user decides to use his/her WiFi-capable camera (e.g., the IP-enabled user device 102D) for the video call so that the audio part (i.e., the audio stream) of the video call is handled by the cell phone and the video part (i.e., the video stream) of the video call is handled by the WiFi-capable camera. The first uses the IP-enabled user device 102A to coordinate the video call, i.e., the IP telecommunication (master user device). The device command modules in the IP-enabled user devices 102A and 102D coordinate the communication thru their respective inter-device handling modules and assign multimedia content generating and playing components accordingly. The second user 104 has selected the IP-enabled user device 104A for the IP telecommunication so that both of the multimedia streams 902-1 and 902-2 are handled by the IP-enabled user device 104A.

In order to execute this multimedia distribution, the first user 102 and the second user 104 make the IP telecommunication involving the multimedia streams 900-1 and 900-2, which may be initiated by either the first use or the second user. This IP telecommunication uses two IP connections, the first IP connection between the IP-enabled user devices 102A and 104A and the second IP connection between the IP-enabled user devices 102D and 104A. The IP-enabled user device 102D is part of the IP telecommunication by maintaining the multimedia stream 902-1 with the IP-enabled user device 104A. The IP-enabled user device 102A is part of the IP telecommunication by maintain the multimedia stream 902-2 with the IP-enabled user device 104A. Each of the IP-enabled user devices involved in the IP telecommunication between the first and second users obtains each other's IP addresses from the gatekeeper server 106.

If there are additional multimedia streams of the IP telecommunication being maintained by the connected the IP-enabled user devices 102A, 102D and 104B, then one or more of these additional multimedia streams can be redirected to another IP-enabled user device in the manner described above with respect to FIGS. 8A and 8B. Alternatively, if the second user 104 want to another of his/her IP-enabled device to handle the second multimedia stream 902-1 or 902-2 of the IP telecommunication, then that multimedia stream can be redirected to another IP-enabled user device under the control of the second user, e.g., the IP-enabled user device, in the manner described above with respect to FIGS. 8A and 8B.

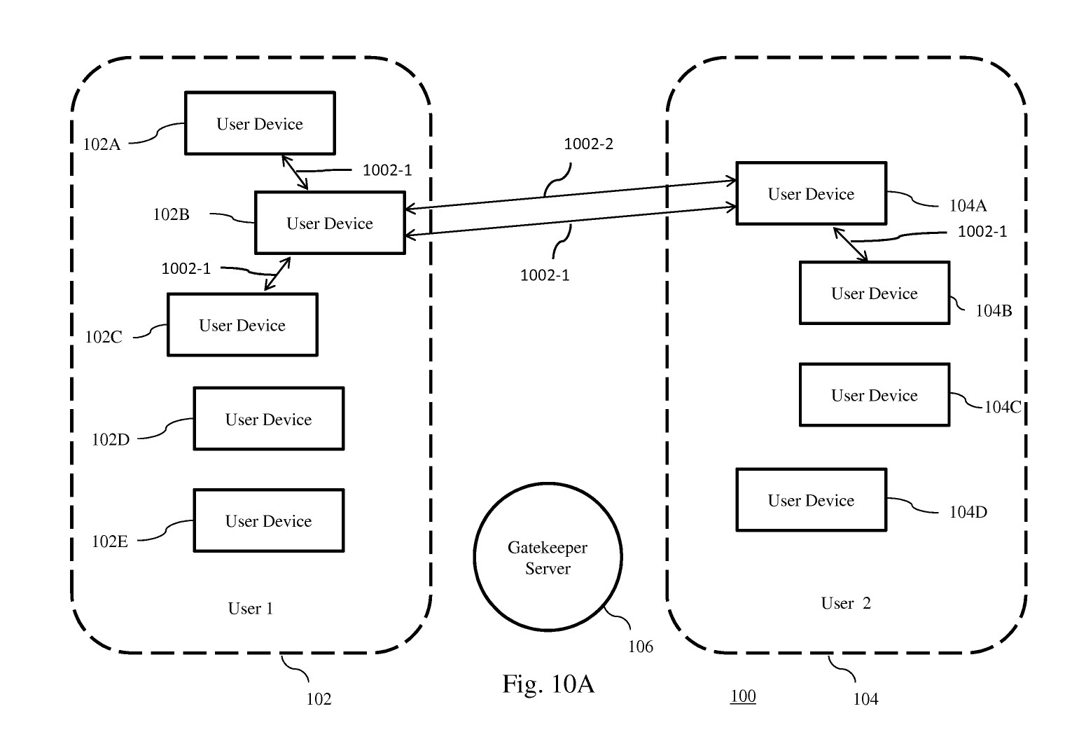

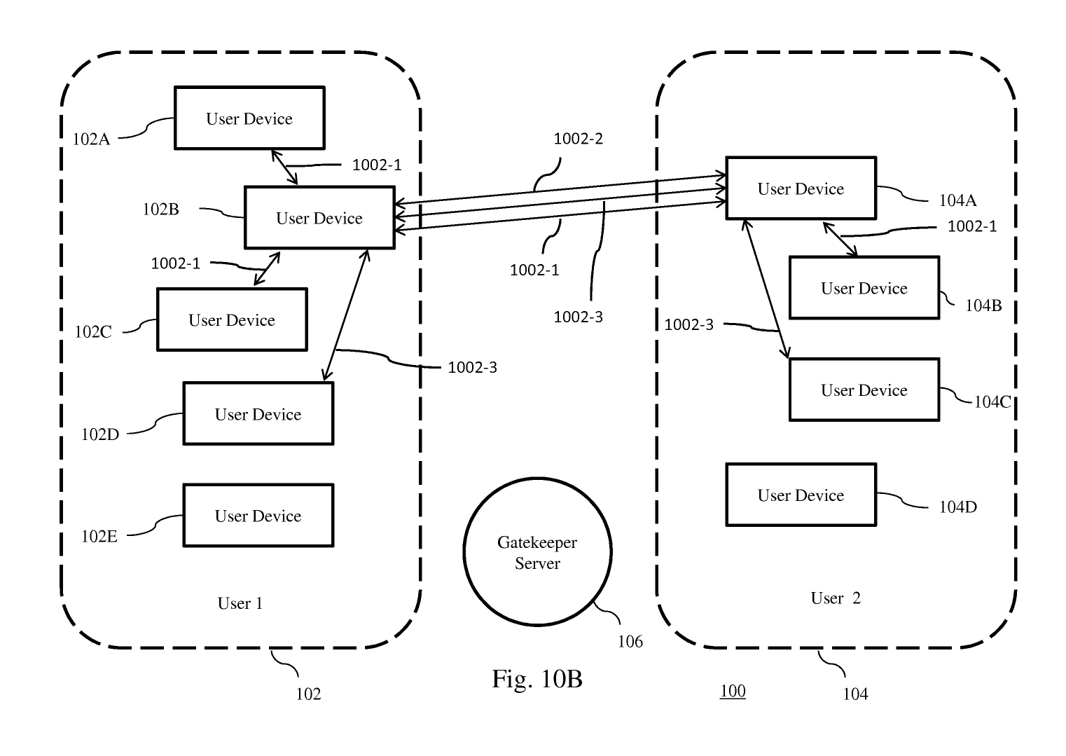

In some embodiments, the IP-enabled user devices in accordance with an embodiment of the invention are able to facilitate relay one or more multimedia streams of an IP telecommunication from one of the IP-enabled user device to other IP-enabled user devices. Thus, users of the IP-enabled user devices can use multiple IP-enabled devices to transmit and receive multimedia streams of the same IP telecommunication. This technique is illustrated with reference to FIGS. 10A and 10B.

In FIG. 10A, the first and second users 102 and 104 want to establish an IP telecommunication involving multimedia streams 1002-1 and 1002-2. The first user has selected the IP-enabled user device 102B for the IP telecommunication, but the IP-enabled user device 102B lacks certain multimedia generating/playing component(s). Thus, the first user decides to use the IP-enabled user devices 102A and 102C, which have the lacking multimedia generating/playing component(s). For example, the first user wants to make a video call to the second user but his/her cell phone (e.g., the IP-enabled user device 102B) does not have a camera. The first user also wants to hear the sound from the loud speaker connected with a WiFi-capable media player (e.g., the IP-enabled user device 102C). Thus, the first user decides to use his/her WiFi-capable camera (e.g., the IP-enabled user device 102A) for the video call so that the audio part (i.e., the audio stream) of the video call is generated by the cell phone and the video part (i.e., the video stream) of the video call is handled by the WiFi-capable camera. In addition, the fist user decides to use his/her WiFi-capable media player to play the received audio part of the video call. The first uses the IP-enabled user device 102B to coordinate the video call, i.e., the IP telecommunication (master user device). The device command module in the IP-enabled user device 102B coordinates the communication thru the inter-device handling module in the IP-enabled user device 102B and assigns multimedia content generating and playing components accordingly. The device command module in the IP-enabled user device 102B commands the IP-enabled user device 102A and the IP-enabled user device 102C to send the multimedia streams 1002-1 and 1002-2 to the IP-enabled user device 102B. The IP-enabled user device 102B relays the received multimedia streams from the IP-enabled user devices 102A and 102C to one or more IP-enabled devices selected by the second user 104.

In FIG. 10A, the second user 104 has selected the IP-enabled user device 104A to coordinate the communication (master user device). The second user decides one or more multimedia streams (e.g., the multimedia stream 1002-1) coming from the first user be played by the IP-enabled user device 104B.

In order to execute this multimedia relay technique, the first user 102 and the second user 104 make the IP telecommunication involving the multimedia streams 1002-1, 1002-2. The IP-enabled user device 102B functions as a master device for the first user and relays or redirects one or more multimedia streams going out to or coming from the second user to the IP-enabled user devices 102A and 102C accordingly. The IP-enabled user device 104A functions as a master device for the second user and relays or redirects one or more multimedia streams (e.g., the multimedia stream 1002-1) going out to or coming from the first user to the IP-enabled user device 104A to the IP-enabled user device 104B accordingly. Each of the IP-enabled user devices involved in the IP telecommunication between the first and second users obtains each other's IP addresses from the gatekeeper server 106.

During the IP telecommunication, the second user 104 may want to redirect certain multimedia stream(s) coming from the IP-enabled user device 102B to another of his/her IP-enabled user device, e.g., the IP-enabled user device 104C. In this example, the second user would then command the device command module in the IP-enabled user device 104A to redirect the wanted multimedia stream(s) to the IP-enabled user device 104C through the IP-enabled user device 104A. The device command module in the IP-enabled user device 104A would then filter the wanted multimedia stream(s) and send out to the IP-enabled user device 104C. Alternatively, the wanted multimedia stream(s) to the IP-enabled user device 104C may be sent directly from the IP-enabled user device 102B to the IP-enabled user device 104C using the technique describe above with respect to FIGS. 8A and 8B.

During the IP telecommunication, the first user 102 may want to add another multimedia stream to the on-going communication with the second user 104. As shown in FIG. 10B, the first user has selected the multimedia stream 1002-3 from the IP-enabled user device 102D. The device command module in the IP-enabled user device 102B would command the IP-enabled user device 102D to send the wanted multimedia stream to the IP-enabled user device 102B. The device command module in the IP-enabled user device 102B would then relay or redirect multimedia streams 1002-1, 1002-2 and 1002-3 to the IP-enabled user device 104A. The device command module in the IP-enabled user device 102B then informs the IP-enabled user device 104A of the addition of the multimedia stream 1002-3. The IP-enabled user device 104A notifies the second user and let the second user choose which of his/her IP-enabled user device handles the additional multimedia stream. In FIG. 10B, the second user has selected the IP-enabled user device 104C to handle the additional multimedia stream. The device command module in the IP-enabled user device 104A would then relay or redirect the multimedia stream 1002-3 to the IP-enabled user device 104C.

Alternatively, rather than relaying the multimedia stream 1002-3 to the IP-enabled user device 104C through the IP-enabled user device, the multimedia stream 1002-3 may be sent directly to the IP-enabled user device 104C from the IP-enabled user device 102B using the technique describe above with respect to FIGS. 8A and 8B.

Although some of the techniques described herein have been described as manipulating bidirectional multimedia streams, these techniques can be applied to unidirectional multimedia streams, where the technique would involve manipulating particular unidirectional multimedia streams. Thus, in some situations, opposite streams for the same multimedia, e.g., audio, may terminate at different IP-enabled users. For example, the outgoing unidirectional multimedia stream of audio may be manipulated differently than the incoming multimedia stream of audio. In addition, in some embodiments, the techniques described herein may involve separating a single multimedia stream so that some portion of that multimedia stream is directed to a first IP-enabled user device and some other portion of that multimedia stream is directed to a second IP-enabled user device.

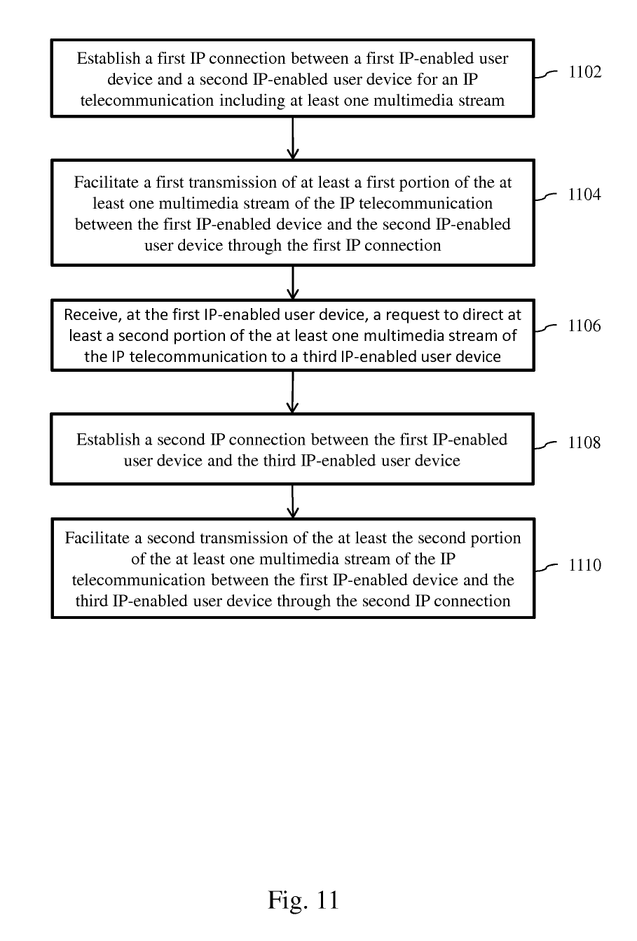

A method for manipulating multimedia streams of IP telecommunications for multiple IP-enabled user devices in accordance with an embodiment of the invention is described with reference to a flow diagram of FIG. 11. At block 1102, a first IP connection between a first IP-enabled user device and a second IP-enabled user device is established for an IP telecommunication including at least one multimedia stream. At block 1104, a first transmission of at least a first portion of the at least one multimedia stream of the IP telecommunication between the first IP-enabled device and the second IP-enabled user device is facilitated through the first IP connection. At block 1106, a request to direct at least a second portion of the at least one multimedia stream of the IP telecommunication to a third IP-enabled user device is received at the first IP-enabled user device. At block 1108, a second IP connection between the first IP-enabled user device and the third IP-enabled user device is established so that the at least the second portion of the at least one multimedia stream of the IP telecommunication is transferred between the first IP-enabled user device and the third IP-enabled user device. At block 1110, a second transmission of the at least the second portion of the at least one multimedia stream of the IP telecommunication between the first IP-enabled device and the third IP-enabled user device is facilitated through the second IP connection.

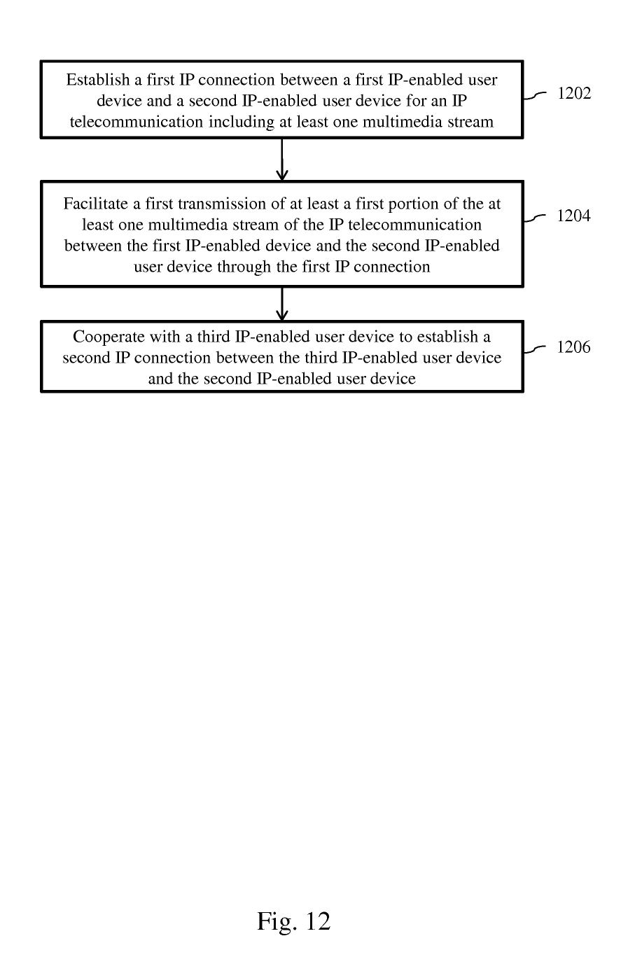

A method for manipulating multimedia streams of IP telecommunications for multiple IP-enabled user devices in accordance with another embodiment of the invention is described with reference to a flow diagram of FIG. 12. At block 1202, a first IP connection between a first IP-enabled user device and a second IP-enabled user device is established for an IP telecommunication including at least one multimedia stream. At block 1204, a first transmission of at least a first portion of the at least one multimedia stream of the IP telecommunication is facilitated between the first IP-enabled device and the second IP-enabled user device through the first IP connection. At block 1206, a third IP-enabled user device is cooperated with to establish a second IP connection between the third IP-enabled user device and the second IP-enabled user device so that at least a second portion of the at least one multimedia stream of the IP telecommunication is transferred between the third IP-enabled user device and the second IP-enabled user device. The IP telecommunication is conducted using both the first IP connection between the first IP-enabled user device and the second IP-enabled user device and the second IP connection between the third IP-enabled user device and the second IP-enabled user to transfer the at least the first portion and the at least the second portion of the at least one multimedia stream of the IP telecommunication between the first, second and third IP-enabled user devices.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for manipulating multimedia streams of IP telecommunications for multiple IP-enabled user devices, the method comprising:
establishing a first IP connection between a first IP-enabled user device and a second IP-enabled user device for an IP telecommunication including at least one multimedia stream;
facilitating a first transmission of at least a first portion of the at least one multimedia stream of the IP telecommunication between the first IP-enabled device and the second IP-enabled user device through the first IP connection;
receiving, at the first IP-enabled user device, a request to direct at least a second portion of the at least one multimedia stream of the IP telecommunication to a third IP-enabled user device;
establishing a second IP connection between the first IP-enabled user device and the third IP-enabled user device so that the at least the second portion of the at least one multimedia stream of the IP telecommunication is transferred between the first IP-enabled user device and the third IP-enabled user device; and
facilitating a second transmission of the at least the second portion of the at least one multimedia stream of the IP telecommunication between the first IP-enabled device and the third IP-enabled user device through the second IP connection.

2. The method of claim 1, terminating the first IP connection between the first IP-enabled user device and the second IP-enabled user device so that the IP telecommunication is performed exclusively between the first and third IP-enabled user device.

3. The method of claim 1, wherein the facilitating the first transmission of the at least the first portion of the at least one multimedia stream of the IP telecommunication includes facilitating the first transmission of a first multimedia stream of the IP telecommunication between the first IP-enabled device and the second IP-enabled user device and wherein the facilitating the second transmission of the at least the second portion of the at least one multimedia stream of the IP telecommunication includes facilitating the second transmission of a second multimedia stream of the IP telecommunication between the first IP-enabled device and the third IP-enabled user device.

4. The method of claim 3, wherein the first multimedia stream of the IP telecommunication is one of a video data stream and the second multimedia stream of the IP telecommunication is an audio data stream or vice versa.

5. The method of claim 1, further comprising relaying, at the first IP-enabled user device, the at least the second portion of the at least one multimedia stream of the IP telecommunication from the third IP-enabled user device to the second IP-enabled user device.

6. The method of claim 1, further comprising relaying, at the first IP-enabled user device, the at least the second portion of the at least one multimedia stream of the IP telecommunication between the second IP-enabled user device and the third IP-enabled user device so that the at least the second portion of the at least one multimedia stream of the IP telecommunication is transmitted through the first IP-enabled user device.

7. The method of claim 6, further comprising relaying, at the first IP-enabled user device, at least a third portion of the at least one multimedia stream of the IP telecommunication between the second IP-enabled user device and a fourth IP-enabled user device so that the at least the third portion of the at least one multimedia stream of the IP telecommunication is transmitted through the first IP-enabled user device.

8. The method of claim 1, further comprising communicating with a fourth IP-enabled user device to establish a third IP connection between the fourth IP-enabled user device and the second IP-enabled user device so that at least a third portion of the at least one multimedia stream is transmitted between the fourth IP-enabled user device and the second IP-enabled user device.

9. The method of claim 1, wherein the at least one multimedia stream includes at least one of audio data, video data, picture or image data, graphics data and textual data.

10. The method of claim 1, wherein the first IP-enabled user device is a desktop computers, a notebook computer, a server, a netbook, a tablet computer, a general media player, a set-top box, a cellular phone, a smart phone, a smart television, a standalone webcam or a network storage.

11. A non-transitory storage medium that stores computer executable instructions, which when executed by a computer, implement a method for manipulating multimedia streams of IP telecommunications for multiple IP-enabled user devices, the method comprising:
establishing a first IP connection between a first IP-enabled user device and a second IP-enabled user device for an IP telecommunication including at least one multimedia stream;
facilitating a first transmission of at least a first portion of the at least one multimedia stream of the IP telecommunication between the first IP-enabled device and the second IP-enabled user device through the first IP connection;
receiving, at the first IP-enabled user device, a request to direct at least a second portion of the at least one multimedia stream of the IP telecommunication to a third IP-enabled user device;
establishing a second IP connection between the first IP-enabled user device and the third IP-enabled user device so that the at least the second portion of the at least one multimedia stream of the IP telecommunication is transferred between the first IP-enabled user device and the third IP-enabled user device; and
facilitating a second transmission of the at least the second portion of the at least one multimedia stream of the IP telecommunication between the first IP-enabled device and the third IP-enabled user device through the second IP connection.

12. The non-transitory storage medium of claim 11, wherein the method further comprises terminating the first IP connection between the first IP-enabled user device and the second IP-enabled user device so that the IP telecommunication is performed exclusively between the first and third IP-enabled user device.

13. The non-transitory storage medium of claim 11, wherein the facilitating the first transmission of the at least the first portion of the at least one multimedia stream of the IP telecommunication includes facilitating the first transmission of a first multimedia stream of the IP telecommunication between the first IP-enabled device and the second IP-enabled user device and wherein the facilitating the second transmission of the at least the second portion of the at least one multimedia stream of the IP telecommunication includes facilitating the second transmission of a second multimedia stream of the IP telecommunication between the first IP-enabled device and the third IP-enabled user device.

14. The non-transitory storage medium of claim 13, wherein the first multimedia stream of the IP telecommunication is one of a video data stream and the second multimedia stream of the IP telecommunication is an audio data stream or vice versa.

15. The non-transitory storage medium of claim 11, further comprising relaying, at the first IP-enabled user device, the at least the second portion of the at least one multimedia stream of the IP telecommunication from the third IP-enabled user device to the second IP-enabled user device.

16. The non-transitory storage medium of claim 11, wherein the method further comprises relaying, at the first IP-enabled user device, the at least the second portion of the at least one multimedia stream of the IP telecommunication between the second IP-enabled user device and the third IP-enabled user device so that the at least the second portion of the at least one multimedia stream of the IP telecommunication is transmitted through the first IP-enabled user device.

17. The non-transitory storage medium of claim 16, wherein the method further comprises relaying, at the first IP-enabled user device, at least a third portion of the at least one multimedia stream of the IP telecommunication between the second IP-enabled user device and a fourth IP-enabled user device so that the at least the third portion of the at least one multimedia stream of the IP telecommunication is transmitted through the first IP-enabled user device.

18. The non-transitory storage medium of claim 11, wherein the method further comprises communicating with a fourth IP-enabled user device to establish a third IP connection between the fourth IP-enabled user device and the second IP-enabled user device so that at least a third portion of the at least one multimedia stream is transmitted between the fourth IP-enabled user device and the second IP-enabled user device.

19. The non-transitory storage medium of claim 11, wherein the at least one multimedia stream includes at least one of audio data, video data, picture or image data, graphics data and textual data.

20. The non-transitory storage medium of claim 11, wherein the first IP-enabled user device is a desktop computers, a notebook computer, a server, a netbook, a tablet computer, a general media player, a set-top box, a cellular phone, a smart phone, a smart television, a standalone webcam or a network storage.

21. A method for manipulating multimedia streams of IP telecommunications for multiple IP-enabled user devices, the method comprising:
establishing a first IP connection between a first IP-enabled user device and a second IP-enabled user device for an IP telecommunication including at least one multimedia stream;
facilitating a first transmission of at least a first portion of the at least one multimedia stream of the IP telecommunication between the first IP-enabled device and the second IP-enabled user device through the first IP connection; and
cooperating with a third IP-enabled user device to establish a second IP connection between the third IP-enabled user device and the second IP-enabled user device so that at least a second portion of the at least one multimedia stream of the IP telecommunication is transferred between the third IP-enabled user device and the second IP-enabled user device,
wherein the IP telecommunication is conducted using both the first IP connection between the first IP-enabled user device and the second IP-enabled user device and the second IP connection between the third IP-enabled user device and the second IP-enabled user to transfer the at least the first portion and the at least the second portion of the at least one multimedia stream of the IP telecommunication between the first, second and third IP-enabled user devices.

22. The method of claim 21, wherein the facilitating the first transmission of the at least the first portion of the at least one multimedia stream of the IP telecommunication includes facilitating the first transmission of a first multimedia stream of the IP telecommunication between the first IP-enabled device and the second IP-enabled user device and wherein the at least the second portion of the at least one multimedia stream of the IP telecommunication transferred between the third IP-enabled user device and the second IP-enabled user device includes a second multimedia stream of the IP telecommunication.

23. The method of claim 22, wherein the first multimedia stream of the IP telecommunication is one of a video data stream and the second multimedia stream of the IP telecommunication is an audio data stream or vice versa.

24. The method of claim 21, further comprising relaying, at the first IP-enabled user device, at least a third portion of the at least one multimedia stream of the IP telecommunication between the second IP-enabled user device and a fourth IP-enabled user device so that the at least the third portion of the at least one multimedia stream of the IP telecommunication is transmitted through the first IP-enabled user device.

25. A non-transitory storage medium that stores computer executable instructions, which when executed by a computer, implement a method for manipulating multimedia streams of IP telecommunications for multiple IP-enabled user devices, the method comprising:
establishing a first IP connection between a first IP-enabled user device and a second IP-enabled user device for an IP telecommunication including at least one multimedia stream;
facilitating a first transmission of at least a first portion of the at least one multimedia stream of the IP telecommunication between the first IP-enabled device and the second IP-enabled user device through the first IP connection; and
cooperating with a third IP-enabled user device to establish a second IP connection between the third IP-enabled user device and the second IP-enabled user device so that at least a second portion of the at least one multimedia stream of the IP telecommunication is transferred between the third IP-enabled user device and the second IP-enabled user device,
wherein the IP telecommunication is conducted using both the first IP connection between the first IP-enabled user device and the second IP-enabled user device and the second IP connection between the third IP-enabled user device and the second IP-enabled user to transfer the at least the first portion and the at least the second portion of the at least one multimedia stream of the IP telecommunication between the first, second and third IP-enabled user devices.

26. The non-transitory storage medium of claim 25, wherein the facilitating the first transmission of the at least the first portion of the at least one multimedia stream of the IP telecommunication includes facilitating the first transmission of a first multimedia stream of the IP telecommunication between the first IP-enabled device and the second IP-enabled user device and wherein the at least the second portion of the at least one multimedia stream of the IP telecommunication transferred between the third IP-enabled user device and the second IP-enabled user device includes a second multimedia stream of the IP telecommunication.

27. The non-transitory storage medium of claim 26, wherein the first multimedia stream of the IP telecommunication is one of a video data stream and the second multimedia stream of the IP telecommunication is an audio data stream or vice versa.

28. The non-transitory storage medium of claim 25, further comprising relaying, at the first IP-enabled user device, at least a third portion of the at least one multimedia stream of the IP telecommunication between the second IP-enabled user device and a fourth IP-enabled user device so that the at least the third portion of the at least one multimedia stream of the IP telecommunication is transmitted through the first IP-enabled user device.

29. An IP-enabled user device comprising, the method comprising:
a user interface module configured to receive user input;
an IP communication core configured establish at least one IP connection to transmit and receive IP data, including different multimedia streams of IP telecommunications;
an inter-device handling module configured to perform functions to interface with other IP-enabled devices to determine which of the IP-enabled user devices will handle the different multimedia streams of the IP telecommunication; and
a device command module coupled to the user interface module, the IP communication core and the inter-device handling module, the device command module being configured to establish a first IP connection between the IP-enabled user device and a second IP-enabled user device for an IP telecommunication including at least one multimedia stream, the device command module being further configured to facilitate a first transmission of at least a first portion of the at least one multimedia stream of the IP telecommunication between the IP-enabled device and the second IP-enabled user device through the first IP connection, the device command module being further configured to establish a second IP connection between the IP-enabled user device and the third IP-enabled user device so that the at least the second portion of the at least one multimedia stream of the IP telecommunication is transferred between the IP-enabled user device and the third IP-enabled user device, the device command module being further configured to facilitate a second transmission of the at least the second portion of the at least one multimedia stream of the IP telecommunication between the first IP-enabled device and the third IP-enabled user device through the second IP connection.
